(19) United States
(12) Patent Application Publication
(10) Pub. No.: US 2018/0174247 A1
(43) Pub. Date: Jun. 21, 2018

(54) A Method of Generating a Production Strategy for the Development of a Reservoir of Hydrocarbon in a Natural Environment

(71) Applicant: REPSOL, S.A., Madrid (ES)

(72) Inventors: Rubén Rodríguez Torrado, Madrid (ES); Giorgio De Paola, Madrid (ES); Sonia Mariette Embid Droz, Madrid (ES)

(21) Appl. No.: 15/579,647

(22) PCT Filed: Jun. 3, 2016
(86) PCT No.: PCT/EP2016/062645

§ 371 Date: Dec. 5, 2017

(30) Foreign Application Priority Data
Jun. 5, 2015 (EP) 15382296.0

(51) Int. Cl. G06Q 50/02; G06Q 10/06; E21B 41/00; E21B 43/20; E21B 43/16

(52) U.S. Cl. CPC G06Q 50/02; G06Q 10/0637; E21B 43/122; E21B 43/20; E21B 43/166; E21B 41/0092

(57) ABSTRACT

The present invention is related to a method of generating a production strategy for the development of a reservoir of hydrocarbon in a natural environment by solving a minimization problem involving, among others, decisional variables, in such a way said decisional variables are reduced or even eliminated by combining them with other continuous variables. The reduction of decisional variables provides a high reduction of the computational cost. The elimination of all decisional variables allow a further reduction of the computational cost as solvers such as Mixed Integer Nonlinear Programming allowing the use of decisional variables that are not needed anymore. A particular case of decisional variables are binary variables.

### OBJECT OF THE INVENTION

The present invention is related to a method of generating a production strategy for the development of a reservoir of hydrocarbon in a natural environment by solving a minimization problem involving, among others, decisional variables, in such a way said decisional variables are reduced or even eliminated by combining them with other continuous variables. The reduction of decisional variables provides a high reduction of the computational cost. The elimination of all decisional variables allow a further reduction of the computational cost as solvers such as Mixed Integer Nonlinear Programming allowing the use of decisional variables that are not needed anymore. A particular case of decisional variables are binary variables.

### PRIOR ART

The number of discoveries of hydrocarbon reserves is expected to decay in the near future. Even when hydrocarbon reserves have been proven for a certain region, it is still quite complicated to produce it. During the last years, new production techniques have taken new relevance to produce complex reservoir which are not economic profitable with natural depletion or water injection.

Determining whether investing in a new hydrocarbon reservoir candidate is a good business decision depends on the inherent value of the reservoir. Decisions around optimum field development plan are extremely delicate due to the high number of variables and the complexity of the phenomena involved (e.g. fluid flow in porous media, interaction between rock and fluid etc.).

Factors determining the inherent value of the reservoir include, for example, the total amount of material that is ultimately recoverable from each new hydrocarbon reservoir (production potential), market prices (oil and/or natural gas prices) and the cost of recovering that material, or capture difficulty. Until the material is actually recovered, however, that inherent value can be estimated among other from numerical simulations.

Even if the available information on certain reservoir allow to low uncertainty regarding the behavior of the rock fluid interaction to be simulated; the value of the reservoir highly depends on the plan strategy used when deploying the facilities.

Variables as the number of wells, the well location, schedule and their control must be defined among others subjected to certain constrains such as the maximum number of wells, the development period or others related to the well control.

It should be stressed that in general all optimization algorithms require a first stage where the search space needs to be explored globally. After this first exploration stage, the solution found is often incrementally improved until some optimization stopping criterion is satisfied. The selection of the algorithm has strong dependency on the type of problem to be solved, the size of the search space or in other words the number of variables to optimize, its robustness to introduce constrains of different type and the search/exploration capabilities.

It is well known in the prior art to provide a high number of strategy plans within a search space wherein decisional variables such as binary variables are involved. The use of binary variables such as those variables indicating that a certain well is a producer well or an injector well imposes the use of solver algorithms requiring a very high computational cost when compared to those solving problems, even non-linear, with only continuous variables.

The present invention proposes a new formulation for generating a field development plan (a production strategy) for reservoirs having a very demanding requirements in terms of computational time to evaluate a non-linear objective function, large size of search space and subjected to a large number of constrains involving decisional variables which results in a simpler optimization model to solve and that requires a lower computational cost for reaching an optimal solution.

### DESCRIPTION OF THE INVENTION

The present invention is a method of generating a production strategy for the development of a reservoir of hydrocarbon in a natural environment involving very demanding requirements and involving categorical decisions that need to be modeled using decisional variables. The decisional variables are the elements under control of the model developer and their values determine the solution of the model. The decisional variable may be represented with an integer. One of the most used decisional variables is the binary decisional variables. Said binary variables are variables that may be represented by two values, true/false, producer/injector, etc. A first example of decisional variable, a binary variable, is that representing the status of a well as productor/injector. A second example of decisional variable is that representing the type of fluid to be injected in a well like water/gas/water-gas mix. In this particular case the decisional variable may take three different values.

The method is interpreted as an computer implemented method wherein the main steps are carried out by means of a computer system.

We denote by x the decisional variable. In a particular framework [symbol] is the set where the decisional variable is, xΣ [symbol] , wherein [symbol] represents integer values.

According to an example, some decisions are responsive to the value of binary decisional variables having two alternative values, a first value and a second value, being the first and the second value of said binary variable adopted as a convention. A method comprising a general formulation of certain condition may be formulated for certain convention but it would be also valid for the contrary convention. Therefore, a condition expressed as:
“the binary variable Bᵢ is water if Sᵢ variable is positive/negative and Bᵢ is gas if Sᵢ variable is negative/positive,”
   should be interpreted as:
“the binary variable Bᵢ is water if Sᵢ variable is positive and Bᵢ is gas if Sᵢ variable is negative; or,
the binary variable Bᵢ is water if Sᵢ variable is negative and Bᵢ is gas if Sᵢ variable is positive”.
   because the method does not depend on a particular convention and both conventions are equivalent.

As it was said before, generating a production strategy for the development of a reservoir of hydrocarbon in a natural environment involves very demanding requirements and, this is particularly true when a low recovery factor is associated with the target reservoir allow the use of the know technique known as Water Alternative Gas (WAG) strategy to enhance hydrocarbon recovery for reservoir.

The use of WAG allows to improve sweep efficiency limiting fingering and hydrocarbon trapping at macroscopic (Water injection—WI) and microscopic (pore) (Gas Injection—GI) level. This is an example of field development plan requiring the use of binary decisional variables, in addition to other binary decisional variables, for instance those indicating if certain well is a producer well or an injection well. This particular example will be deeply described as a preferred embodiment.

A first aspect of the invention is a method of generating a production strategy, also identified as a field development plan, wherein part of the result is the layout of the wells in the field and their control.

The selection of a field development plan is the output of the most profitable and risk-acceptable configuration associated to a compendium of field and operational constrains. In the application of optimization methods to real fields, key elements of success are: a flexible formulation able to include the required constrains and a robust algorithm to deal with a variety of variables in number and types. This very general problem taking into account all of this aspects may be addressed by applying the first aspect of the invention in an affordable manner.

According to a first aspect of the invention, the method generates a production strategy for the development of a reservoir of hydrocarbon in a natural environment limited by a surface (A) where the well layout is defined. The method comprises the following steps:

a) determining an objective function to be maximized f depending at least on:
the continuous variables representing the well locations Pᵢ, i=1 . . . N per well, being N the number of wells,
the continuous variables representing the well controls Zᵢ, i=1 . . . N ; and,
one decisional variable B_{L}, i=1 . . . N per well;

The objective function to be maximized is commonly an economic measure, as the Net Present Value (NPV), varying variables such as type, locations, control and drilling schedule, subjected to several operational constrains (i.e. maximum number of wells, minimum gas injection, inter-well-distance, the surface (A) where the well locations are, etc . . . ).

The same problem may be formulated using a minimization problem but, in this case, the method is interpreted as an equivalent method.

Step a) comprises the minimum variables that need to be taken into account for the layout of the wells and their control; that is, the well location in the surface (A) identified by the continuous variables Pᵢ, i=1 . . . N wherein index i=1 . . . N represents the i^{t h} well among the N wells. The number of wells, according to a preferred embodiment, is not an optimization variable but a restriction. Once the optimum is reached the number of wells can be computed by post-processing, that is, summing the perforated wells that are determined by the decisional variables Bᵢ. More complex scenarios may require optionally additional variables such as the continuous variables representing the gas lift rates per well GLᵢ, i=1 . . . N, being the gas lift an artificial-lift method in which gas is injected into the production tubing to reduce the hydrostatic pressure of the fluid column and it allows the reservoir liquids to enter the wellbore at a higher flow rate.

Step a) also involves an at least one decisional variable Bᵢ, i=1 . . . N per well. This decisional variable requires the use of particular solvers being able to deal with decisional variables taking into account for instance integer variables or Boolean variables. These solvers are more expensive in terms of computational cost and the complexity of the problem to solve and the cost increases with the total number of decisional variables.

This problem is solved by the invention by:
b) determining a transformation of variables by combining at least one decisional variable Bᵢ and one or more non-decisional variables (Pᵢ, Zᵢ) into a new continuous variable Sᵢ and, determining non-decision over the variable Sᵢ, being the number of non-decision equal to the number of all possible decisions such that:
   for the non-decisional variables to be combined, when one of the non-decisional variable takes a non-zero value, the rest of non-decisional variables are null; and,—the non-decisional variables Pᵢ, Zᵢ and the decisional variable Bᵢ are responsible from the values of Sᵢ and from the conditions within the space of decisions.

Each new continuous variable Sᵢ involving the combination of one decisional variable and one or more continuous variable reduces the total number of variables to be solved and, additionally one of the reduced variables are the decision ones which are the variables having high impact in the computational cost.

One of the most important examples of decisional variables is those showing two different conditions, a first and a second condition. These particular conditions may be easily implemented using Boolean variables. More complex decisional variables may comprises a higher number of values that may be implemented using integer variables.

The new variable Sᵢ, taking into account the conditions, gathers the whole information of all combined variables.

As an embodiment, if the decisional variable only has two different conditions, the sign function may be used as an efficient function providing the first and the second condition responsive to the continuous variable Sᵢ.

In a preferred embodiment the first and second condition is the sign of the Sᵢ variable such that the binary variable Bᵢ combined when defining the Sᵢ variable takes its first value if Sᵢ is positive/negative and its second value if Sᵢ is negative/positive. Then, the first condition may be expressed as Sᵢ>0 and the second condition may be expressed as Sᵢ<0. More complex conditions may also be expressed for instance y using a cut-off value different from zero.

In a particular embodiment, three variables (one binary decisional variable and two continuous variables) are combined into a single continuous Sᵢ one. The two continuous variables, the injection of water rate and the injection of gas rate in the same well, show non-zero values in different intervals of their time domain. The new continuous Sᵢ variable gathers the information of the binary variable (the sign of Sᵢ), the information of the water injection (for instance the positive values of Sᵢ) and the gas injection (for instance the negative values of Sᵢ interpreted as positive; that is, the absolute value but only for the intervals of Sᵢ being negative).

Additionally the method comprises:
c) determining the constrains to be satisfied for the selected variables;
d) solving the optimization problem defined by the objective function f expressed as a function of the new combined variables Sᵢ plus the non combined variables of step a) by means of a solver restricted to the constrains.

Those variables that have not been combined are kept. The optimization problem involves a reduced number of variables as the subset of combined variables has reduced the total number of variables and each combination has eliminated a binary decisional variable. However, the solved problem provides information of all variables as the new Sᵢ variables allow reconstructing the values of the combined ones.

Once the problem has been solved with a lower computational cost the method comprises:
e) determining the original variables of step a) defined before the combination from the variables used by the solver,
f) making at least one of the original variables available.

An specific embodiment of making at least one of the original variables available is by providing a production strategy in response to the optimal computed values expressed in the original values.

The output of the method is the same as a method using the original variables defined in step a) but incurring in a lower computational cost.

A second aspect of the invention is a computer program product configured to carry out a method as disclosed.

A third aspect of the invention is a system for the development of a reservoir of hydrocarbon in a natural environment deployed according to a production strategy defined by a method as disclosed.

### DESCRIPTION OF THE DRAWINGS

These and other features and advantages of the invention will be seen more clearly from the following detailed description of a preferred embodiment provided only by way of illustrative and non-limiting example in reference to the attached drawings.

FIG. 1 This figure shows a schematic layout of wells in a hydrocarbon reservoir limited by a surface (A).

FIG. 2 This figure shows a WAG injection scheme and the set of functions involved in the method according to an embodiment for one specific well.

### DETAILLED DESCRIPTION OF THE INVENTION

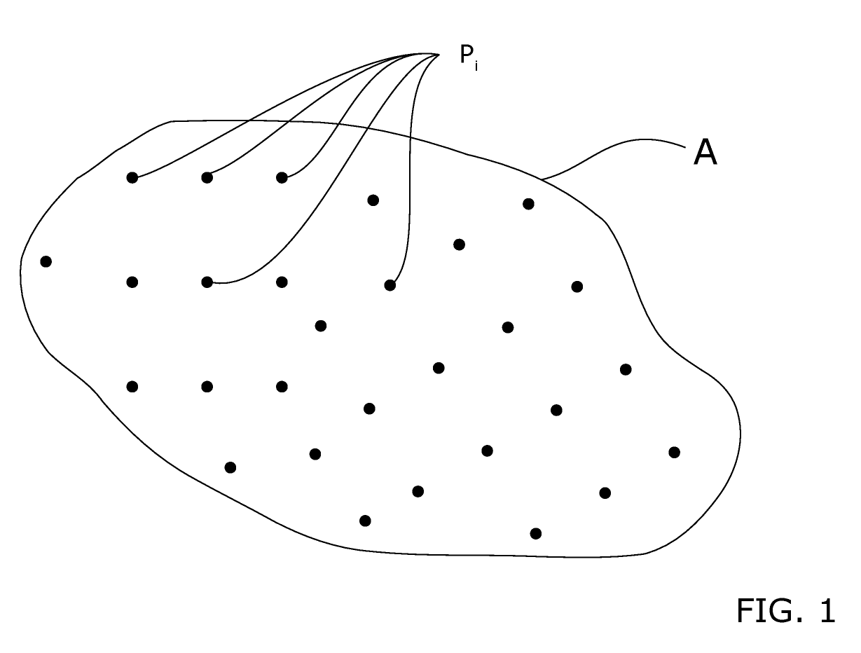

The present invention is a method for generating a production strategy for the development of a reservoir of hydrocarbon in a natural environment which is being limited in its surface by region that hereinafter will be identified as surface (A), in which a layout of wells and the control over said wells is also provided. FIG. 1 shows an embodiment of the surface (A) located over a reservoir. In this figure, a set of well locations are depicted which has been calculated according to an optimization method wherein said optimization method involves additional variables such as the well control.

A specific embodiment of the invention is disclosed wherein said specific embodiment implements several improvements of the method according to the invention in order to understand several particularities and possibilities that provides a further reduction of the computational cost.

The embodiment is a method for a field development plan optimization generalized for continuous phase (water or gas) and/or WAG injection. The proposed optimization problem covers well placement, control, schedule and gas lift under uncertainty. This problem inherently formulated as Mixed Integer Nonlinear Programing (MINLP) is relaxed to a Nonlinear Programing with non-linear constrains in order to take into account operational restrictions. A Particle Swarm Optimization (PSO) algorithm, has been used to solve this nonlinear optimization problem. The use of a real field as test bench poses additional strength on the robustness of the formulation in presence of a large number of decisional variables (e.g. tens of variables) and constrains.

Water Alternative Gas (WAG) injection is proposed as one of the main production mechanism of a target reservoir. WAG schemes allow improving sweep efficiency limiting fingering and hydrocarbon trapping at macroscopic.

The proposed method, according to this embodiment, allows determining the complete optimum field development (number, position, schedule and control of the wells) for WAG scheme.

In the present formulation due to the very nature of the WAG strategy, the limited number of wells to locate, the morphology of the reservoir and the presence of already drilled wells, the use for instance of a pattern strategy is discouraged and a well-to-well optimization has been considered instead. This means that the dimension of the problem to solve is large. To have an order of magnitude if we only had to solve for the WAG cycle definition the problem would scale roughly as twice the number of wells plus three additional variables for the time frequency multiplied the number of WAG period.

In order to reduce the number of variables and allowing standard optimization tools to be efficiently employed special care was given to the formulation. Due to the non-linear operational constrains, the highly non-linear objective function and the use of categorical decisional variables, the optimization problem so formulated as a Mixed Integral Non Linear Programing (MINLP) has been relaxed to a more advantageous Nonlinear Programing.

An additional constrain which is being considered during the formulation and the selection of the solution method is the computational burden associated to each simulation. As global figure the computational time associated to the simulation of a production strategy on the studied field is around 8 hrs/processor.

In order to have an efficient optimization the algorithm used is required to scale well with the problem size, perform an efficient global search and be able to handle different type of variable. PSO technique has been selected applied due to the success in solving efficiently well placement problems.

Optimization Problem

The optimization problem can be formalized as follows:

$${max}_{x ∈ Ω , {x}_{d} ∈ {Ω}_{d} , {x}_{b} ∈ {Ω}_{b}} f ( x , {x}_{d} , {x}_{b} ) , subject to c ( x , {x}_{d} , {x}_{b} ) \leq 0$$

$$x = \{ {Z}_{i} , {P}_{i} , {GL}_{i} , {B}_{i} \}$$

Z identifies well control, P well location, GL gas lift variables and B any decision optimization variables; and N the number of wells.

f is the objective function we seek to maximize (i.e. NPV) with:
Ω={x⊖ [symbol] ⁿ: xᵢ≤x≤xᵤ} being xᵢ,xᵤ the lower and upper limit respectively, and Ω the continuous space of well control and gas lift;
Ω_{d}={x_{d}⊖ [symbol] ⁿ′: x_{di}≤x≤x_{du}} being x_{di},x_{du}, the lower and upper limit respectively in the discrete space, and Ω_{d} is said discrete space to identify the cell drilling location;
Ω_{b}={x_{b}⊖ [symbol] ⁿ″: x_{b}=0,1} is the binary decisional space of well type, decisional variables to identify drill/not-drill (for instance x_{b} =0 representing “drill” and x_{b}=1 representing “not-drill”), injector/producer, gas/water phases;
c is the constrain vector cδ [symbol] ^{m}.
The vector x is composed by the well-to-well optimization variables solved concurrently; and,
n,n′,n″ the dimension of each former space.

Reduction of Variables

Well Control—WAG Cycle Definition

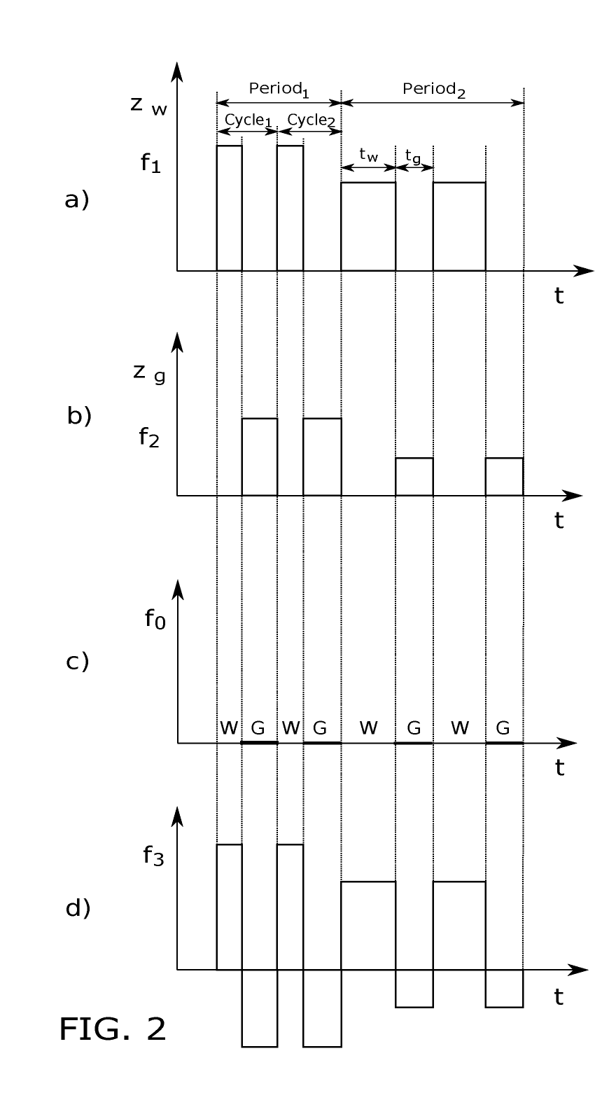

As it is shown in FIG. 2a-d), the WAG strategy consists in batches of water and gas applied alternatively. From here on we define as cycle the sequence of one batch of water and one of gas and as period the length of consecutive identical cycles. A cycle is described mainly by four variables: the fluid injection rate and the batch duration in time (days), for any batches of water or gas. A period is defined by the number of cycles as shown in FIG. 2a).

FIG. 2 shows four functions:
a binary decisional variable (f₀) indicating that, being the well and injector well, water of gas is being injected;
two non-decisional variables, a first variable according to a function wherein its value represents the rate of water injected; and, a second variable according to a function wherein its value represents the rate of gas injected.

Function (f₁) represents the rate of water being injected as a function of time and function (f₂) represents the rate of gas being injected as a function of time.

When water is being injected through the injector well no gas is being injected and, when gas is being injected through the injector well no water is being injected. Water and gas injection are exclusive alternatives.

f1 and f₂ meets the following criterion: if one non-decisional function is non-zero, then the other non-decisional variables must be null. Additionally, f₁ is non-zero when the binary decisional variable indicates that the well is injecting water and f₂ is non-zero when the binary decisional variable indicates that the well is injecting gas.

According to an embodiment of the invention, a new function f₃ is defined combining the binary decisional variable and both non-decisional variables, f₁ and f₂; that, is, the water injection rate (Z_{w}) and the gas injection rate (Z_{g}) respectively.

Function f₃ takes the value of f₁ when the decisional variable takes the value (W); and, takes the value of f₂ when the decisional variable takes the value (G). The values of f₀, f₁, f₂ can be recovered from f₃ as follows:
f₀=W if f₃ is positive and f₀=G if f₃ is negative.;
f₁=f₃ if f₃>0 and f₁=0 elsewhere;
f₂=−f₃ if f₃<0 and f₂=0 elsewhere.

In particular, for the implementation of this example, f₀ values are obtained from the sign(x) function checking whether f₃ is positive or negative, and f₁ and f₂ are the water injection rate (z_{w}) and the gas injection rate (z_{g}) respectively. f₃ has been normalized ranging between −1 and 1.

The categorical variable switches between fluids, water and gas when the well is injecting a fluid into the reservoir.

Therefore, a relaxation to the problem formulation has been applied in order to reduce the number of variables and to avoid categorical ones yet linearizing the production constrain. This space transformation allows to relax the binary decisional variables to a sign function Ω∪Ω_{b}→Ω_{rb}{x⊖ [symbol] ⁿ}.

A variable z is defined to determine the well WAG injector rate function of the WAG period and batch type. The variable bounds are defined as:

z_{w,i,t}≤z_{w,i,t}≤z̅_̅{̅w̅,̅i̅,̅t̅}̅

z_{g,i,t}≤z_{g,i,t}≤z̅_̅{̅g̅,̅i̅,̅t̅}̅
with i⊖Nᵢ, t⊖T
   where N₁ is the number of injector wells, T the number of periods. From now on, i index will indicate that the variable is associated to an injector well and the t index indicate that the variable is associated to certain period. g index will denote gas and w index will denote water.

That is, for instance, the summation Σ_{iϵNi}z_{g,i,t} extended over a flow rate z_{g,i,t} indicates that the flow rate in the well is the gas injection rate (identified by the g index), i index indicates that summation is extended over all injection wells and t index identify certain period. Variables related to the well are represented with lowercase letters and variables related to the production of the reservoir, the sum of all wells, are represented with uppercase letters.

The lower and upper bar _, ^{—} are the lower and upper bounds respectively. The optimization variables x input to the optimization algorithm are bounded between −1 (gas) and 1 (water). The sign is associated with the injection behavior, in other words, negative means gas injection and positive water injection; and the module rescaled within its lower and upper bound is the amount of water/gas to be injected. The mathematical description for the WAG operational restrictions is then as follow:

$$if {x}_{i , t} > 0 \qquad {z}_{w , i , t} = \underline{{z}_{w , i , t}} + ( \overline{{z}_{w , i , t}} - \underline{{z}_{w , i , t}} ) \vert {x}_{i , t} \vert$$

$$if {x}_{i , t} < 0 \qquad {z}_{g , i , t} = \underline{{z}_{g , i , t}} + ( \overline{{z}_{g , i , t}} - \underline{{z}_{g , i , t}} ) \vert {x}_{i , t} \vert$$

$$wherein$$

$${Z}_{gas , t} = {\sum }_{i ∈ Ni} {z}_{g , i , t}$$

$${Z}_{water , t} = {\sum }_{i ∈ Ni} {z}_{w , i , t}$$

under the constrains

$$\underline{{Z}_{GAS}} < {Z}_{gas , t} < \overline{{Z}_{GAS}}$$

$$\underline{{Z}_{WATER}} < {Z}_{water , t} < \overline{{Z}_{WATER}}$$

$$t ∈ T$$

as Z_{WATER}, Z_{GAS} are the bounded field values. The formulation is generic enough to covers the case of standard water injection strategy. Finally, three new variables are introduced: t^{g}, t_{w} and f. Where t^{g} is the period gas injection time (single batch), t^{w} period water injection time (single batch) and fr the number of time a cycle is repeated within the period. The length of on WAG period ΔT can be defined as:

Δ̅T̅≤ΔT=(t^{g}+t^{w})*fr≤ΔT

with the additional constrain

$${\sum }_{t ∈ T} ( {t}_{t}^{g} + {t}_{t}^{w} ) * {fr}_{t} \leq {T}_{sim}$$

with Tₛᵢₘ the simulated time. This constrain not only allows to determine the period duration but it can also be used to constrain any period to a specific event imposed by the operator, hence, computing fr as a post processing and reducing its variability.

Well number, location and schedule

According to this embodiment, in order to define the location and the number of wells, the reservoir can be clustered in areas with high production potential. The clusters definition is conditioned to the reservoir location and to the well type (producers injectors). This cell ensemble, identified by the discrete cell index, is then linearized into one continuous variable for easier treatment in the optimization problem. Each candidate well is associated to such a variable and a sign function used to determine the status drill or not-drill if respectively positive or negative. The total number of wells is then computed therefrom. Considered that there are no restrictions in the well location but the cluster, inherently the schedule is associated to the position vector.

Restriction on the well distance has also been applied in the aim of reducing the interference between drainage radius.

The restriction itself should not be necessary considered that the optimum should reduce the well interference to maximize NPV, it is yet consider important to speed up the algorithm convergence. The formulation can be summarized as:

∥Pᵢ−Pⱼ∥₂≥d, ∀i, j⊖N_{welltot}i≠j

Pᵢ=r(y) with yϵ [symbol] , Pᵢϵ [symbol] ²

with Pᵢ being the location of well i and the function r(y) used to convert the continuous and normalized optimization variable y in a discrete cell value. The function r(y) is a mapping function having as input a continuous normalized bounded variable y and as output the well location belonging to a predefined area sub ensemble of A non-necessarily continuous or convex. The well location is later mapped into a cell index value identified by its coordinate pair. N_{welltot} is the total number of wells in the field including any pre-existing ones.

This part of the formulation has been described by a total of N_{wellmax} variables being the max number of wells possible to drill in the field. Noteworthy, each location variable is composed by a continuous and binary problem [0,1] that will be treated accordingly as described in the optimization algorithm. The total number of new perforated wells is then computed as the sum of Producers N_{P} and Injectors N_{I}:

N_{wells}=Σᵢ^{N}^{_{wellmax}} max(sign(yᵢ), 0) with N_{wells}=N_{P}N_{I} subject to

N_{P}≤N_{P}≤N̅_̅{̅P̅}̅ and N_{I}≤N_{I}≤N̅_̅{̅I̅}̅

Gas Lift

In order to determine the gas lift optimization, a variable representing the gas lift rate per well has been introduced. The formulation reads:

gl≤glᵢ≤g̅l̅

where the glᵢ is the dimensional gas lift rate and is bounded between its upper g̅l̅ and lower gl bound. An additional linear constrain should be added to include the field upper limit:

$${\sum }_{i = 1}^{Np} {gl}_{i} \leq \overline{GL}$$

Where N_{P} is the number of producer wells and G̅L̅ the upper boundary of the field gas lift rate. N_{P} is therefore the total number of variables associated to the gas lift formulation.

Solver

A particle Swarm Optimization algorithm has been used. The PSO algorithm is easily parallelizable since, at each iteration, the evaluation of all particles in the swarm can be performed concurrently.

As was expressed earlier the optimization problem involves continuous and categorical variables. In the present formulation all categorical are binary decisional variables associated with a sign function. A hybrid PSO/Binary PSO has been therefore proposed allowing the solution of the coupled problem.

The optimization problem formulated above has been carried out using a single objective function based on the NPV. This is the most common formulation in field development plan optimization; however, it may bring to unwanted solution based on operator sentiments and experience which cannot be introduced in a proper mathematical formulation. Examples could be a development plan with a too large or too small number of wells yet presenting a high NPV. Large number of wells, for example, can introduce logistic problems on how to deal with the drilling, too small number can result in a high oil production par well increasing the dependence of the field production to a too limited number of wells.

In order to present the most suitable optima, in this studies we related all the simulated field development into a Pareto plot. The idea is to rank the solutions, optimized on NPV, with respect to other important figures such as field oil production and number of wells. In view of the Pareto plot the operator and the partners can decide the most suitable plan in view of a pool of optima solution.

The performance of the optimization algorithm has result very efficient when compared with the same problem using only original variables involving all the decisional variables.

In case of PSO for example the reduction in optimization variables reduces the size of the domain improving the particle search when compared to the prior art.

For instance, according to said prior art, an alternative approach using brute force, allowing all variables to be optimized without problem relaxation, yields to the use of a larger number of particles and algorithm iterations reducing the overall performances.

The increase in computational cost is more evident for common well-known alternative optimization algorithms (i.e. based on the evaluation of the numerical gradient of the objective function). In these cases the number of simulation to perform scales as twice the number of optimization variables making the problem prohibitive to be solved.

Because in the disclosed embodiment all decisional variables have been combined with non-decisional variables, the resulting problem has been solved with more efficient solvers as non-decisional variables are involved. The post-processing cost for recovering the original variables is almost negligible compared to the computational cost of the solver; therefore, the combination and recovering steps are not detrimental to the efficiency of the present invention.

1. A method for generating a production strategy for development of a reservoir of hydrocarbon in a natural environment, wherein said natural environment is limited by a surface (A), the method comprising the following steps carried out by means of a computer system:
a) determining an objective function to be maximized f depending at least on:
a decisional variable i=1 . . . N per well, wherein being N is the number of wells, non-decisional variables representing well locations Pᵢ, i=1 . . . N on the surface (A),
non-decisional variables representing well controls Zᵢ, i=1 . . . N; and,
b) determining a transformation of variables by combining at least one decisional variable Bᵢ and one or more non-decisional variables (Pᵢ,Zᵢ) into a new non-binary variable Sᵢ and, determining conditions over the variable Sⱼ, wherein the number of conditions is equal to the number of all possible decisions such that:
for the non-decisional variables to be combined, when one of the non-binary variable takes a non-zero value, the rest of non-binary variables are null; and,
the non-decisional variables Pᵢ,Zᵢ and the decisional variable Bᵢ are responsible from the values of Sᵢ and from the conditions within the space of decisions,
c) determining the constrains to be satisfied for the selected variables;
d) solving an optimization problem defined by the objective function expressed as a function of the new combined variables Sᵢ plus the non combined variables of step a) by means of a solver restricted to the constrains;
e) determining the original variables of step a) defined before the combination from the variables used by the solver;
f) providing a production strategy in response to the optimal computed values expressed in the original values.

2. The method according to claim 1, wherein in step a), the objective function to be maximized f further depends on the non-decisional variables representing the gas lift rates per well GLᵢ, i=1 . . . N; and, on step b), the GLᵢ, i=1 . . . N is a further variable among the rest of continuous variables.

3. The method according to claim 1, wherein in step b), each decisional variable Bᵢ, i=1 . . . N is combined with one or more non-decisional variables Pᵢ,Zᵢ,GLᵢ; i=1 . . . N into N new non-decisional variables Sᵢ; i=1 . . . N begin the optimization problem defined by the objective function f expressed only on non-decisional variables; and, wherein the solver is a non-linear solver.

4. The method according to claim 1, wherein the objective function to be maximized I depends at least on a binary decisional variable Bᵢ, i=1 . . . N indicating that the well is either a production well (PW) or an injection well (IW).

5. The A method according to claim 1, wherein the objective function to be maximized f depends at least on a binary decisional variable Bᵢ, i=1 . . . N indicating that the well, if the well is an injector well, is either injecting water (W) or injecting gas (G).

6. The method according to claim 1, wherein decision condition is binary and the space of decisions comprises a first and a second condition, being said conditions the sign of the Sᵢ variable such that the binary variable Bᵢ takes its first value if Sᵢ is positive/negative and its second value if Sᵢ is negative/positive.

7. The method according to claim 1, wherein for certain injection well (IW), the well control is defined by the combination of:
a binary variable Bᵢ indicating that the well is injecting water (W) well or the well is injecting gas (G) well,
a well control Z_{wi} for the water injection; and,
a well control Z_{gi} for the gas injection,
into a new variable Sᵢ representing the well control according to a Water Alternative Gas strategy as follows:
the injection alternates the injection in batches of water and gas along a period of time,
the period of time comprises one or more cycles, being a cycle defined as the sequence of one batch of water and one of gas; and,
a cycle is defined by the fluid injection rate and the batch duration in time;
wherein
the Bᵢ is water if Sᵢ variable is positive/negative and Bᵢ is gas if Sᵢ variable is negative/positive,
the takes the values of |Sᵢ| is sign (Sᵢ) is positive/negative and zero otherwise; and,
the takes the values of |Sᵢ| is sign (Sᵢ) is positive/negative and zero otherwise.

8. The method according to claim 1, wherein the objective function to be maximized f is the net present value.

9. A computer program product configured to carry out a method according to claim 1.

10. A system for the development of a reservoir of hydrocarbon in a natural environment deployed according to a production strategy defined by a method according to claim 1.
